(19) United States
(12) Patent Application Publication
(10) Pub. No.: US 2020/0041849 A1
(43) Pub. Date: Feb. 6, 2020

(54) LIQUID CRYSTAL ALIGNING AGENT FOR TFT SUBSTRATE AND METHOD FOR FABRICATING LIQUID CRYSTAL DISPLAY PANEL

(71) Applicant: SHARP KABUSHIKI KAISHA, Sakai City, Osaka (JP)

(72) Inventors: Hiroaki ASAGI, Sakai City (JP); Isamu MIYAKE, Sakai City (JP)

(21) Appl. No.: 16/339,873

(22) PCT Filed: Oct. 2, 2017
(86) PCT No.: PCT/JP2017/035777

§ 371 Date: Apr. 5, 2019

(30) Foreign Application Priority Data
Oct. 7, 2016 (JP) 2016-199139

(51) Int. Cl. G02F 1/1337

(52) U.S. Cl. CPC G02F 1/133723; G02F 2001/133354

(57) ABSTRACT

The present invention provides a liquid crystal aligning agent for a TFT substrate, a liquid crystal display panel, and a method for fabricating a liquid crystal display panel, capable of preventing the decrease in panel yield caused by ink repelling. The liquid crystal aligning agent for a TFT substrate, containing a polymer and a solvent, wherein the liquid crystal aligning agent contains 10% by weight or more of diisobutyl ketone relative to a total weight, the TFT substrate includes a channel protection film, and the channel protection film includes an insulating film containing silicon and nitrogen.

### TECHNICAL FIELD

The present invention relates to a liquid crystal aligning agent for a TFT substrate and a method for fabricating a liquid crystal display panel. More particularly, the present invention relates to a liquid crystal aligning agent for a TFT substrate suitable when a liquid crystal alignment film is formed on a TFT substrate that includes a channel protection film including an insulating film containing silicon and nitrogen, and a method for fabricating a liquid crystal display panel suitable when a TFT substrate includes a channel protection film including an insulating film containing silicon and nitrogen.

### BACKGROUND ART

A liquid crystal display panel has been used in a wide variety of fields taking advantage of its merits of being thin, light weight, and low power. The liquid crystal display panel is provided with a pair of substrates sandwiching a liquid crystal layer, and normally has a TFT substrate in which a thin-film transistor (TFT) is formed as one of the paired substrates. On each of the substrates, a liquid crystal alignment film is formed of a liquid crystal aligning agent containing a polymer such as polyamic acid and polyimide and a solvent, and the initial alignment direction of liquid crystal molecules in the liquid crystal layer is controlled by the liquid crystal alignment films.

In Patent Literature 1, for example, a composition for formation of a liquid crystal alignment film is disclosed that contains a material for formation of a liquid crystal alignment film and contains, as a solvent, at least one of γ-butyrolactone and N-methyl-2-pyrrolidone, diethylene glycol diethyl ether, and diisobutyl ketone, as the composition for formation of a liquid crystal alignment film excellent in application property even in use for ink-jet printing and also excellent in flatness.

A channel layer of a TFT formed in a TFT substrate has been conventionally formed using a silicon semiconductor such as amorphous silicon, polycrystalline silicon, and monocrystalline silicon. In recent years, however, development of a TFT using an oxide semiconductor, in place of a silicon semiconductor, has been actively carried out for reducing the leakage current flowing to the TFT in its off-state (see Patent Literature 2 and 3, for example).

### CITATION LIST

### Patent Literature

Patent Literature 1: WO 2009/107406
Patent Literature 2: WO 2016/076168
Patent Literature 3: JP 2012-134475 A

### SUMMARY OF INVENTION

### Technical Problem

A TFT using an oxide semiconductor is normally required to use an insulating film containing silicon and nitrogen as a channel protection film. This worsens the wettability of the TFT substrate including such a TFT and, when a liquid crystal aligning agent is applied to the TFT substrate, repelling of the liquid crystal aligning agent (hereinafter referred to as ink repelling or simply repelling) may occur remarkably, causing noticeable decrease in panel yield.

Also, while the TFT using an oxide semiconductor is advantageous for a high-definition liquid crystal display panel from the viewpoint of the size of the TFT, repelling may occur remarkably when a liquid crystal aligning agent is applied to the TFT substrate for a high-definition liquid crystal display panel. With the recent advances in ultra-high definition liquid crystal display panels used for smartphones, notebook PCs, etc., the density of contact holes of the TFT substrate for a high-definition liquid crystal display panel has become high, increasing the aspect ratio of the irregularities. In such a panel, in the step of applying a liquid crystal aligning agent to the TFT substrate with an ink-jet applicator, the liquid crystal aligning agent may fail to flow into the contact holes, causing repelling.

The present invention has been made in view of the above circumstances and aims to provide a liquid crystal aligning agent for a TFT substrate, and a method for fabricating a liquid crystal display panel, capable of preventing the decrease in panel yield caused by ink repelling.

### Solution to Problem

One aspect of the present invention may be a liquid crystal aligning agent for a TFT substrate containing a polymer and a solvent, wherein the liquid crystal aligning agent contains 10% by weight or more of diisobutyl ketone relative to a total weight, the TFT substrate includes a channel protection film, and the channel protection film includes an insulating film containing silicon and nitrogen.

A definition of the TFT substrate may be 300 ppi or more.

The TFT substrate may be provided with a contact hole having a depth of 2 μm or more.

The liquid crystal aligning agent may be applied to the TFT substrate by an ink-jet application method.

The liquid crystal aligning agent may contain one or more kinds of poor solvents including diisobutyl ketone, and the proportion of diisobutyl ketone in the one or more kinds of poor solvents may be 30% or more.

The concentration of the polymer in the liquid crystal aligning agent may be 4% by weight or less.

The TFT substrate may include a TFT containing an oxide semiconductor.

The oxide semiconductor may be indium gallium zinc oxide.

A thickness of the insulating film may be 50 nm or more.

The polymer may include at least one kind of polymer selected from the group consisting of polyamic acid and soluble polyimide.

The polymer may contain a linear alkylene group with two or more carbons.

The polymer may contain a fluorine atom.

The polymer may include two or more kinds of polymers.

Another aspect of the present invention may be a liquid crystal display panel including a liquid crystal alignment film formed of the liquid crystal aligning agent for a TFT substrate of the above aspect of the present invention on the TFT substrate.

Yet another aspect of the present invention may be a method for fabricating a liquid crystal display panel including a TFT substrate, the TFT substrate including a channel protection film, and the channel protection film including an insulating film containing silicon and nitrogen, the method including a step of applying a liquid crystal aligning agent containing a polymer and a solvent to the TFT substrate to form a liquid crystal alignment film, and the liquid crystal aligning agent contains 10% by weight or more of diisobutyl ketone relative to a total weight.

The definition of the TFT substrate may be 300 ppi or more.

The TFT substrate may be provided with a contact hole having a depth of 2 μm or more.

The liquid crystal aligning agent may be applied to the TFT substrate by an ink-jet application method.

The liquid crystal aligning agent may contain one or more kinds of poor solvents including diisobutyl ketone, and the proportion of diisobutyl ketone in the one or more kinds of poor solvents may be 30% or more.

The concentration of the polymer in the liquid crystal aligning agent may be 4% by weight or less.

The TFT substrate may include a TFT containing an oxide semiconductor.

The oxide semiconductor may be indium gallium zinc oxide.

The thickness of the insulating film may be 50 nm or more.

The polymer may include at least one kind of polymer selected from the group consisting of polyamic acid and soluble polyimide.

The polymer may contain a linear alkylene group with two or more carbons.

The polymer may contain a fluorine atom.

The polymer may include two or more kinds of polymers.

These aspects of the present invention described above may appropriately be combined within the spirit of the present invention.

### Advantageous Effects of Invention

The liquid crystal aligning agent for a TFT substrate of the one aspect of the present invention, which is a liquid crystal aligning agent for a TFT substrate that includes a channel protection film including an insulating film containing silicon and nitrogen, contains 10% by weight or more of diisobutyl ketone relative to the total weight, whereby the decrease in panel yield caused by ink repelling can be prevented.

In the method for fabricating a liquid crystal display panel of the yet another aspect of the present invention, a TFT substrate includes a channel protection film including an insulating film containing silicon and nitrogen, but a liquid crystal aligning agent contains 10% by weight or more of diisobutyl ketone relative to the total weight, whereby the decrease in panel yield caused by ink repelling can be prevented.

### BRIEF DESCRIPTION OF DRAWINGS

FIG. 1 is a cross-sectional view schematically showing a TFT substrate according to Embodiment 1.

FIG. 2 is a cross-sectional view schematically showing a TFT substrate on which a liquid crystal alignment film is formed according to Embodiment 1.

### DESCRIPTION OF EMBODIMENTS

Hereinafter, an embodiment of the present invention will be described. The embodiment is not intended to limit the scope of the present invention, and any design change can be made appropriately as long as the constituents of the present invention are satisfied.

### <Liquid Crystal Aligning Agent>

First, the liquid crystal aligning agent of this embodiment will be described. The liquid crystal aligning agent of this embodiment is a liquid crystal aligning agent for a TFT substrate, used for forming a liquid crystal alignment film (hereinafter simply referred to as an alignment film) on the TFT substrate. The liquid crystal aligning agent of this embodiment contains, as in a general liquid crystal aligning agent, one or more kinds of polymers (hereinafter also referred to as alignment film polymers) as an alignment film material and one or more kinds of solvents, where the alignment film polymer is dissolved in the solvent. Note that the liquid crystal aligning agent may also be one called a composition for formation of a liquid crystal alignment film or an alignment film ink.

The TFT substrate includes a channel protection film for a TFT, and the channel protection film includes at least an insulating film containing silicon and nitrogen (hereinafter also referred to as a nitride insulating film), as will be described later in detail. Therefore, as described above, when a general liquid crystal aligning agent is applied to such an insulating film, ink repelling tends to occur frequently. However, the liquid crystal aligning agent of this embodiment, which contains 10% by weight or more of diisobutyl ketone (2,6-dimethyl-4-heptane; hereinafter also abbreviated as DIBK) relative to the total weight, can effectively prevent occurrence of ink repelling, achieve high contact hole burying rate and prevent the decrease in panel yield caused by ink repelling.

As used herein, the weight ratio (% by weight) of an ingredient (e.g., DIBK) relative to the total weight refers to the weight ratio (% by weight) of the ingredient relative to the weight of the entire liquid crystal aligning agent, representing the proportion (% by weight) of the weight of the ingredient with respect to the weight of the entire liquid crystal aligning agent blended as the reference (100%). The contact hole burying rate as used herein refers to an indicator representing the rate of contact holes into which a liquid crystal aligning agent has flowed, in the total contact holes, to form an alignment film. The calculation thereof will be described in detail in examples.

If the content of DIBK is less than 10% by weight, the contact hole burying rate may become extremely low because of ink repelling occurring around contact holes, raising the possibility of causing decrease in panel yield.

Using diethylene glycol butyl methyl ether (1-[2-(2-methoxyethoxy)ethoxy]butane; hereinafter also abbreviated as BDM) that has a surface tension as low as that of DIBK, however, the contact hole burying rate cannot be improved, unlike the case of using DIBK. This is considered because DIBK plays a role like a surfactant, reducing the interface tension at the surface of the TFT substrate thereby assisting flow of the liquid crystal aligning agent of this embodiment into contact holes.

In the conventional material development, inks having low surface tension have been developed to improve the application property. The present inventors have found the followings. The application property of a liquid crystal aligning agent to the above TFT substrate having a nitride insulating film is not improved in some cases even though lowering of the surface tension of the agent is achieved. In order to uniformly apply the liquid crystal aligning agent to the TFT substrate having a nitride insulating film, the liquid crystal aligning agent is required to contain 10% by weight or more of DIBK relative to the total weight.

From the viewpoint of the yield, the liquid crystal aligning agent of this embodiment preferably contains 12% by weight or more of DIBK relative to the total weight. The liquid crystal aligning agent of this embodiment preferably contains 10% by weight or more and 45% by weight or less, more preferably 12% by weight or more and 30% by weight or less, further preferably 12% by weight or more and 20% by weight or less, of DIBK relative to the total weight.

The liquid crystal aligning agent of this embodiment contains one or more kinds of poor solvents including DIBK, and the proportion of DIBK in the one or more kinds of poor solvents is preferably 30% or more. This can lead to reduction in the amount of an unnecessary residual solvent after the application and baking of the liquid crystal aligning agent of this embodiment, contributing to improvement in the reliability of the alignment film formed. The reason is that DIBK is low in boiling point compared with other poor solvents (alcoholic and ether solvents generally used as poor solvents).

Note that, in this specification, the proportion of a given poor solvent (hereinafter referred to as the target poor solvent) in the one kind or two or more kinds of poor solvents was calculated in the following manner. First, the weight ratio (% by weight) of each poor solvent to the total weight is calculated, and then the proportion (%) of the weight ratio of the target poor solvent with respect to the total of the weight ratios (% by weight) of all poor solvents as the reference (100%) is calculated.

The poor solvent contained in the liquid crystal aligning agent of this embodiment may be DIBK, and the proportion of DIBK in the one or more kinds of poor solvents may be 30% or more and 100% or less. The proportion of DIBK in the one or more kinds of poor solvents may be 30% or more and 99% or less, or 40% or more and 90% or less.

As described above, DIBK is preferably a poor solvent for an alignment film polymer. The poor solvent refers to a solvent in which the alignment film polymer is not completely dissolved in its general concentration range, and preferably a solvent in which at least part of the alignment film polymer is not dissolved at 24° C. when the concentration of the alignment film polymer in the poor solvent is 2% by weight.

Examples of the poor solvent other than DIBK include butyl cellosolve (ethylene glycol monobutyl ether; hereinafter also abbreviated as BC), 1-buthoxy-2-propanol, diethylene glycol diethyl ether, diethylene glycol ethyl methyl ether, diethylene glycol dimethyl ether, and diethylene glycol butyl methyl ether. Among others, BC is preferred. The liquid crystal aligning agent of this embodiment preferably contains DIBK and BC. The proportion of DIBK in the two kinds of poor solvents is preferably 30% or more and 99% or less, more preferably 40% or more and 90% or less. The proportion of BC in the two kinds of poor solvents is preferably 1% or more and 70% or less, more preferably 10% or more and 60% or less.

In general, the liquid crystal aligning agent of this embodiment further contains one or more kinds of good solvents from the viewpoint of uniformly dispersing the alignment film polymer in the liquid crystal aligning agent of this embodiment. The good solvent refers to a solvent in which the alignment film polymer is dissolved substantially entirely (preferably completely) in its general concentration range, and preferably a solvent in which the alignment film polymer is dissolved substantially entirely (preferably completely) at 24° C. when the concentration of the alignment film polymer in the good solvent is 10% by weight.

The above good solvent is not particularly limited, and may be, for example, N-methyl-2-pyrrolidone (N-methyl pyrrolidone; hereinafter also abbreviated as NMP), 1-ethyl-2-pyrrolidone, γ-butyrolactone (hereinafter also abbreviated as γ-BL), and N,N′-dimethyl-2-imidazolidinone. Among others, NMP and γ-BL are preferred. The liquid crystal aligning agent of this embodiment preferably contains NMP and γ-BL. The proportion of NMP in the two kinds of good solvents is preferably 60% or more and 80% or less, more preferably 65% or more and 75% or less. The proportion of γ-BL in the two kinds of good solvents is preferably 20% or more and 40% or less, more preferably 25% or more and 35% or less.

In this specification, the proportion of a given good solvent (hereinafter referred to as a target good solvent) in the one kind or two or more kinds of good solvents was calculated in the following manner. First, the weight ratio (% by weight) of each good solvent relative to the total weight is calculated, and then the proportion (%) of the weight ratio of the target good solvent with respect to the total of the weight ratios (% by weight) of all good solvents as the reference (100%) is calculated.

In the liquid crystal aligning agent of this embodiment, the percentages of the good solvent and the poor solvent in the entire solvent are not particularly limited but can be appropriately determined according to the solubility of the alignment film polymer. Preferably, the proportion of the good solvent in the entire solvent is 55% or more and 90% or less, more preferably 60% or more and 88% or less, further preferably 65% or more and 85% or less. The proportion of the poor solvent in the entire solvent is preferably 10% or more and 45% or less, more preferably 12% or more and 40% or less, further preferably 15% or more and 35% or less. In general, a horizontal alignment film polymer that forms a horizontal alignment film is less easily dissolved in the solvent than a vertical alignment film polymer that forms a vertical alignment film. However, by increasing the proportion of the good solvent in the liquid crystal aligning agent of this embodiment as described above, a horizontal alignment film polymer can be sufficiently dissolved in the solvent according to this embodiment.

Note that, in this specification, the proportion of the good solvent or the poor solvent in the entire solvent was calculated in the following manner. First, the weight ratio (% by weight) of each solvent relative to the total weight is calculated, and then the weight ratios (% by weight) of all good solvents or all poor solvents are summed.

The concentration of the alignment film polymer in the liquid crystal aligning agent of this embodiment, i.e., the weight ratio (% by weight) of the alignment film polymer relative to the total weight is not particularly limited. From the viewpoint of reducing the viscosity of the liquid crystal aligning agent of this embodiment to further improve the wettability, the concentration is preferably more than 0% by weight and 5% by weight or less, more preferably more than 0% by weight and 4% by weight or less, further more preferably 2% by weight or more and 3.5% by weight or less.

The kind of the above alignment film polymer is not particularly limited, but can be appropriately determined according the display mode of the liquid crystal display panel. Preferably, the alignment film polymer includes at least one kind of polymer selected from the group consisting of polyamic acid and soluble polyimide. Such a polyamic acid polymer has high actual performance in use as an alignment film material, and, using this, a liquid crystal display panel with high reliability and high liquid crystal alignment property can be obtained. The polyamic acid polymer also has an advantage of being capable of selecting a wide range of materials when two or more kinds of polymers described later are used or when an alkylene group, fluorine, etc. are introduced into the polymer. This advantage contributes to the high reliability and the high liquid crystal alignment property. The soluble polyimide refers to a polyimide that is substantially entirely (preferably completely) dissolved in a good solvent in a general concentration range of the alignment film polymer. Preferably, the soluble polyimide is substantially entirely (preferably completely) dissolved in a good solvent at 24° C. when the concentration of the soluble polyimide in the good solvent is 10% by weight.

As the alignment film polymer, a polymer including an alkyl chain in its chemical structure can be used for the purpose of improving the liquid crystal alignment property. However, since the alkyl chain is hydrophobic, the alignment film polymer including an alkyl chain in its structure tends to cause ink repelling. Using the solvent composition according to this embodiment, however, such an alignment film polymer can be applied to the TFT substrate without problems. Thus, from the viewpoint of improving the liquid crystal alignment property, the alignment film polymer preferably includes an alkyl chain represented by —(CH₂)ₙ— (where n=2 or more). In other words, the alignment film polymer preferably includes a linear alkylene group with two or more carbons.

From a similar viewpoint, the alignment film polymer preferably has a main chain including the alkyl chain (linear alkylene group), and preferably includes a diamine having the alkyl chain (linear alkylene group) and at least one of a polyamic acid obtained by polymerizing tetracarboxylic dianhydride and a soluble polyimide obtained by cyclodehydrating the polyamic acid. The number n of carbons of the alkyl chain (linear alkylene group) is preferably 15 or less, more preferably 10 or less, further preferably 5 or less.

As the alignment film polymer, a polymer including a fluorine atom in its chemical structure may be used. Since the fluorine atom is hydrophobic like the alkyl chain, ink repelling tends to occur. However, using the solvent composition according to this embodiment, such an alignment film polymer can be applied to the TFT substrate without problems. In particular, the alignment film polymer preferably has a side chain having a fluorine atom at its end, and preferably includes a diamine having a fluorine atom at the site that is to be the side-chain end and at least one of a polyamic acid obtained by polymerizing tetracarboxylic dianhydride and a soluble polyimide obtained by cyclodehydrating the polyamic acid.

Two kinds of, or two or more kinds of, alignment film polymers may be used. When two kinds of polymers are used, one kind of polymer contributes to improving the liquid crystal alignment property and the other kind contributes to improving the reliability and electrical properties of the alignment film. Also, during pre-drying (pre-baking) process, the two kinds of polymers are separated into two layers using surface energy difference, where the upper layer (layer closer to the liquid crystal layer) is formed of the alignment film polymer contributing to the liquid crystal alignment property, and the lower layer (layer closer to the TFT substrate) is formed of the alignment film polymer contributing to the reliability and electrical properties of the alignment film. Having such a material system, in order to allow the layer separation to proceed using the surface energy difference, the alignment film polymer forming the upper layer inevitably has a hydrophobic polymer structure. Therefore, the liquid crystal aligning agent for the two-layer alignment film has a concern over the application property compared with a liquid crystal aligning agent for a one-layer alignment film. However, using the solvent composition according to this embodiment, such an alignment film polymer can be applied to the TFT substrate without problems. When three or more kinds of polymers are used, also, during pre-drying process, layer separation proceeds according to the difference in surface energy among the alignment film polymers. The uppermost layer contributes to improvement of the liquid crystal alignment property, a middle layer contributes to improvement of both the liquid crystal alignment property and the electrical properties, and a lower layer contributes to adjustment of the electrical properties and improvement of the reliability, although this depends on the blend ratio of these alignment film polymers. When the difference in surface energy among the three or more kinds of materials is sufficiently great, the layer separation appears remarkably. When the energy difference is small among these materials, an alignment film having gradation is formed. When there is no energy difference among the materials, an alignment film where the materials are uniformly mixed is formed. In other words, among the two or more kinds of alignment film polymers as the materials constituting the alignment film, the alignment film polymer lowest in surface energy and highest in hydrophobicity forms the uppermost layer (liquid crystal alignment layer), and the alignment film polymer highest in surface energy and highest in hydrophilicity forms the lowermost layer. From the viewpoint of making the layer separation remarkable, among the surface energy values of the layers each formed of a single one of the two or more kinds of alignment film polymers, the difference between the highest surface energy and the lowest surface energy may be 5 to 15 mJ/m².

The alignment film polymer may be a horizontal alignment film polymer that forms a horizontal alignment film or a vertical alignment film polymer that forms a vertical alignment film, but a horizontal alignment film polymer is preferred.

### <Method for Fabricating Liquid Crystal Display Panel>

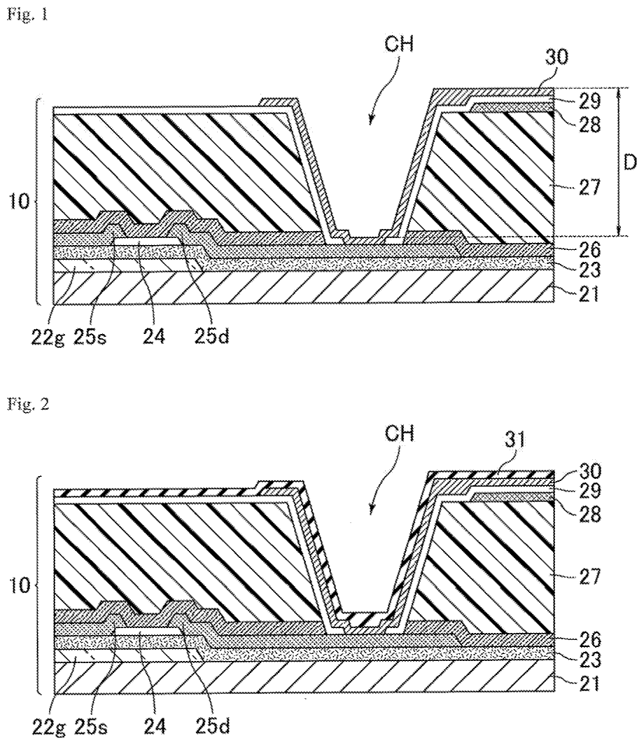

Next, the method for fabricating a liquid crystal display panel of this embodiment will be described. FIG. 1 is a cross-sectional view schematically showing a TFT substrate according to Embodiment 1.

First, a TFT substrate 10 having a fringe field switching (FFS) electrode structure as shown in FIG. 1 and a general counter substrate (not shown) are prepared.

As shown in FIG. 1, in the TFT substrate 10, a gate electrode 22g is formed on a substrate 21 such as a glass substrate. The gate electrode 22g is constituted by a laminated film of a copper (Cu) film having a thickness of 200 to 500 nm and a titanium (Ti) film having a thickness of 20 to 50 nm laminated in this order from the substrate 21 side.

The gate electrode 22g may be constituted by a laminated film of a titanium film having a thickness of 40 to 60 nm, an aluminum (Al) film having a thickness of 150 to 250 nm, and a titanium film having a thickness of 40 to 60 nm laminated from the substrate 21 side; a laminated film of a tantalum (Ta) film having a thickness of 40 to 60 nm and a tungsten (W) film having a thickness of 350 to 450 nm laminated from the substrate 21 side; a single-layer film of any one of a titanium film, a molybdenum (Mo) film, a tantalum film, a tungsten film, and a copper film; an alloy film of these single-layer films; or a laminated film of some of these single-layer films.

A gate insulator 23 is formed on the gate electrode 22g. The gate insulator 23 is constituted by a laminated film of a silicon nitride (SiNₓ) film having a thickness of 300 to 400 nm and a silicon oxide (SiO₂) film having a thickness of 40 to 60 nm laminated from the gate electrode 22g side. In place of the silicon nitride film constituting the laminated film, a silicon oxynitride film (SiONₓ) film having a thickness of 300 to 400 nm may be used.

A rectangular channel layer 24 extending backward as viewed from the front side of FIG. 1 is formed, striding over the gate electrode 22g, on the gate insulator 23. The channel layer 24 is formed of an oxide semiconductor having a thickness of 50 to 200 nm: for example, the channel layer 24 is formed of indium gallium zinc oxide (hereinafter also referred to as an In—Ga—Zn—O semiconductor) having a thickness of 50 to 200 nm. The In—Ga—Zn—O semiconductor is a ternary oxide of indium (In), gallium (Ga), and zinc (Zn), the ratio (composition ratio) of which is not particularly limited, and may be In:Ga:Zn=2:2:1, In:Ga:Zn=1:1:1, or In:Ga:Zn=1:1:2, for example. Among others, an In—Ga—Zn—O semiconductor including In, Ga, and Zn at 1:1:1 is preferable.

The In—Ga—Zn—O semiconductor may be amorphous or include a crystalline portion exhibiting crystallinity. As a crystalline In—Ga—Zn—O semiconductor, a crystalline In—Ga—Zn—O semiconductor in which the c axis is aligned roughly vertically to the layer surface is preferable. The crystal structure of such a crystalline In—Ga—Zn—O semiconductor is disclosed in Patent Literature 3 cited above, for example, the entire contents of which is incorporated herein by reference. A TFT using an In—Ga—Zn—O semiconductor having crystallinity as the channel layer 24 is capable of stabilizing the properties by reducing variations in threshold voltage and also ensuring high reliability by decreasing the amount of movable ions in the gate insulator 23.

In place of the In—Ga—Zn—O semiconductor, another oxide semiconductor may be used. The channel layer 24 may include, for example, a Zn—O semiconductor (ZnO), an In—Zn—O semiconductor (IZO (registered trademark)), a Zn—Ti—O semiconductor (ZTO), a Cd—Ge—O semiconductor, a Cd—Pb—O semiconductor, CdO (cadmium oxide), a Mg—Zn—O semiconductor, an In—Sn—Zn—O semiconductor (e.g., In₂O₃—SnO₂—ZnO), or an In—Ga—Sn—O semiconductor.

Rectangular source electrode 25s and drain electrode 25d are formed extending in directions away from each other (left and right directions as viewed from FIG. 1) from both ends of the channel layer 24 in the channel length direction. As shown in FIG. 1, the source electrode 25s is formed to extend leftward from the upper left end of the channel layer 24, and the drain electrode 25d is formed to extend rightward from the upper right end of the channel layer 24. Like the gate electrode 22g, each of the source electrode 25s and the drain electrode 25d is constituted by a laminated film of a copper film having a thickness of 150 to 400 nm and a titanium film having a thickness of 20 to 40 nm laminated in this order from the substrate 21 side.

The source electrode 25s and the drain electrode 25d may be constituted by a laminated film of a titanium film having a thickness of 40 to 60 nm, an aluminum film having a thickness of 150 to 250 nm, and a titanium film having a thickness of 40 to 60 nm laminated from the substrate 21 side; a single-layer film of any one of a titanium film, a molybdenum film, a tantalum film, a tungsten film, and a copper film; an alloy film of these single-layer films; or a laminated film of some of these single-layer films.

A channel protection film (passivation film) 26 as an insulating film is formed on the source electrode 25s, the drain electrode 25d, and the portion of the channel layer 24 not covered with the source and drain electrodes. The channel protection film 26 is constituted by a laminated film of a silicon oxide (SiO₂) film having a thickness of 150 to 450 nm (preferably 200 to 400 nm) and a nitride insulating film (an insulating film containing silicon and nitrogen) laminated from the channel layer 24 side. The nitride insulating film is not particularly limited, but a silicon nitride (SiNₓ) film, a silicon oxynitride (SiONₓ) film, or a laminated film of these films is preferred.

A resin film 27 is formed on the channel protection film 26. The resin film 27 is constituted by a resin film such as an acrylic resin film, and the thickness thereof is 1 to 3 μm (preferably 1.5 to 2.5 μm).

A common electrode 28 is formed on the resin film 27. The common electrode 28 is constituted by a transparent conductor such as ITO, and the thickness thereof is 50 to 250 nm (preferably the thickness of 100 to 200 nm). The common electrode 28 is formed over the entire display region excluding a contact hole formation region described later and used for applying a common voltage to pixels.

An insulating film (interlayer insulating film) 29 is formed on the common electrode 28 and the portion of the resin film 27 not covered with the common electrode 28. The insulating film 29 is constituted by a silicon nitride (SiNₓ) film having a thickness of 100 to 200 nm. In place of the silicon nitride film, a silicon oxide film or a silicon oxynitride film having a thickness of 100 to 200 nm may be used.

Openings are formed through the channel protection film 26 and the resin film 27 at the same position on the drain electrode 25d, and the side faces of the channel protection film 26 and the resin film 27 in the openings are covered with the insulating film 29. The insulating film 29 also has an opening in the openings of the channel protection film 26 and the resin film 27. A contact hole CH is formed of these openings. Via the contact hole CH, the drain electrode 25d is connected with a pixel electrode 30 described later.

The depth D of the contact hole CH is not particularly limited, but as the contact hole CH is deeper, ink repelling occurs more easily. Using the liquid crystal aligning agent of this embodiment, however, even if the depth D of the contact hole CH is great, application of the agent can be made without problems. More specifically, the liquid crystal aligning agent of this embodiment is particularly preferred when the depth D of the contact hole CH is 2 μm or more, capable of effectively preventing occurrence of ink repelling. The depth D of the contact hole CH may be 1.5 μm or more and 4 μm or less, more preferably 2 μm or more and 3 μm or less.

The depth D of the contact hole CH refers to the height from the surface of the deepest portion of the TFT substrate 10 in the contact hole CH to the surface of the topmost portion of the TFT substrate 10 on the periphery of the contact hole CH in the direction normal to the substrate 21 at the stage where the members other than an alignment film have been formed. As shown in FIG. 1, the depth D of the contact hole CH may be the height from the surface of the deepest portion of the pixel electrode 30 in the contact hole CH to the surface of the topmost portion of the pixel electrode 30 on the periphery of the contact hole CH in the direction normal to the substrate 21.

The planar shape of the contact hole CH is not particularly limited, and may be rectangular, circular, or oval, for example. The smallest diameter of the contact hole CH is not particularly limited, and may be 4 to 8 μm, for example.

A plurality of pixel electrodes 30 are formed on the insulating film 29. Each pixel electrode 30 is constituted by a transparent conductor such as ITO, and the thickness thereof is 50 to 150 nm (preferably the thickness of 100 to 200 nm). The pixel electrode 30, provided for each pixel, is used for applying a voltage (video signal) to each pixel. Also, a plurality of slit openings are formed through each pixel electrode 30 above the common electrode 28.

The positions of the pixel electrodes 30 and the common electrode 28 may be interchanged: the pixel electrodes 30, the insulating film 29, and the common electrode 28 may be laminated in this order from the resin film 27 side. In this case, a plurality of slit openings are formed, not through the pixel electrode 30, but through the common electrode 28, in each pixel region.

The insulating films constituting the TFT substrate 10 are required to have their appropriate film thickness designs to ensure the insulation property, the moisture resistance, and the flatness. However, as the insulating films are thicker, the contact hole CH becomes higher, resulting in easier occurrence of ink repelling.

For the channel protection film 26, for example, a silicon oxide (SiO₂) film, a silicon nitride (SiNₓ) film, a silicon oxynitride (SiONₓ) film, or a laminated film thereof can be used as described above. An oxide semiconductor such as an In—Ga—Zn—O semiconductor has a nature of easily changing the threshold characteristic of the TFT under the influence of moisture. Therefore, when an oxide semiconductor is used, it is highly preferable to use, as the channel protection film 26, a nitride insulating film such as a silicon nitride film and a silicon oxynitride film having high moisture resistance. At this time, if a nitride insulating film such as a silicon nitride film and a silicon oxynitride film, which contains hydrogen in large quantity, is directly laminated on the channel layer 24, the hydrogen will be dispersed into the channel layer 24, causing the oxide semiconductor such as the In—Ga—Zn—O semiconductor to become conductive turning the characteristic to the conductive mode. For this reason, when an oxide semiconductor is used, the most preferred configuration is to provide a silicon oxide film to impart insulation property, and further a nitride insulating film such as a silicon nitride film and a silicon oxynitride film to impart moisture resistance, on the channel layer 24.

In such a configuration of the TFT substrate 10, since the channel protection film 26 serves as the lower layer (layer most unlikely to contact with the liquid crystal aligning agent) of the layer structure constituting the height of the contact hole CH, if a nitride insulating film is further provided (particularly if the thickness thereof is great), the panel yield caused by application of a liquid crystal aligning agent will be greatly worsened.

Using a liquid crystal aligning agent with increased DIBK like the liquid crystal aligning agent of this embodiment, however, the application property can be sufficiently ensured even when a nitride insulating film is present and when the thicknesses of the resin film 27 and the other insulating films vary. In other words, with the liquid crystal aligning agent of this embodiment, a liquid crystal display panel including the TFT substrate 10 having TFT characteristics excellent in insulation property, moisture resistance, and flatness can be fabricated with high panel yield.

The thickness of the nitride insulating film is not particularly limited. However, the liquid crystal aligning agent of this embodiment is particularly preferred when the thickness of the nitride insulating film is 50 nm or more, in which case, occurrence of ink repelling can be effectively prevented. The thickness of the nitride insulating film may be 30 nm or more and 250 nm or less, more preferably 50 nm or more and 200 nm or less.

The definition of the TFT substrate 10 is not particularly limited, but as the definition is higher, the density of contact holes CH becomes higher, reducing the length of flat portions between adjacent contact holes CH and thus causing ink repelling more easily. Using the liquid crystal aligning agent of this embodiment, however, application of the agent can be made without problems even when the definition of the TFT substrate 10 is high. Specifically, the liquid crystal aligning agent of this embodiment is preferred when the definition of the TFT substrate 10 is 300 pixels per inch (ppi) or higher, in which case, in particular, occurrence of ink repelling can be effectively prevented.

The liquid crystal aligning agent of this embodiment containing a polymer and a solvent is then applied to both the TFT substrate 10 and the counter substrate. As described above, ink repelling tends to occur on the TFT substrate 10 that has the channel protection film 26 including a nitride insulating film. However, the liquid crystal aligning agent of this embodiment, which contains 10% by weight or more of diisobutyl ketone (DIBK) relative to the total weight, can be applied even to the TFT substrate 10 on which ink repelling tends to occur.

The application method of the liquid crystal aligning agent of this embodiment is not particularly limited, but an ink-jet application method is preferred. The ink-jet application method tends to cause ink repelling compared with other application methods such as a printing method. Using the liquid crystal aligning agent of this embodiment, however, application of the agent can be made by the ink-jet method with hardly causing ink repelling.

FIG. 2 is a cross-sectional view schematically showing a TFT substrate on which a liquid crystal alignment film is formed according to Embodiment 1. After the application, the applied films are leveled for a while (for 30 seconds to 2 minutes), and then the substrates are pre-dried (pre-baked) at 60 to 100° C. for 2 to 5 minutes. This allows the solvent in the liquid crystal aligning agent to volatilize, forming an alignment film on each of the substrates. In this way, as shown in FIG. 2, an alignment film 31 is formed on the TFT substrate 10.

Subsequently, each substrate is subjected to full-scale drying (baking) at 170 to 250° C. for 30 minutes to 2 hours. This allows the solvent to further volatilize from the alignment film. Simultaneously, imidization, thermal polymerization reaction and/or thermal cross-linking reaction of the alignment film polymer proceed, enhancing the reliability of the alignment film.

The alignment film formed on each substrate according to this embodiment may be a horizontal alignment film that aligns liquid crystal molecules in the liquid crystal layer roughly horizontally or a vertical alignment film that aligns liquid crystal molecules in the liquid crystal layer roughly vertically, but a horizontal alignment film is preferred. The film thickness of the alignment film after the full-scale drying is preferably 50 to 200 nm, more preferably 70 to 150 nm.

Alignment treatment such as photo-alignment and rubbing is then performed for the alignment film on each substrate.

Thereafter, the space between the TFT substrate 10 and the counter substrate is filled with a liquid crystal composition (liquid crystal material) by vacuum injection or one drop filling, to form the liquid crystal layer. For the vacuum injection, steps of applying a sealing material, bonding the TFT substrate 10 and the counter substrate together, hardening the sealing material, injecting the liquid crystal composition, and sealing the fill port are performed in this order. For the one drop filling, steps of applying a sealing material, dropping the liquid crystal composition, bonding the TFT substrate 10 and the counter substrate together, and hardening the sealing material are performed in this order. As a result, a liquid crystal cell filled with the liquid crystal composition is produced.

After the above steps, a step of sticking a polarizing plate and a step of attaching a control unit, a power supply unit, a backlight, etc. are performed, to complete the liquid crystal display panel of this embodiment. The liquid crystal display panel of this embodiment may be constituted by, in addition to the above members, a plurality of members including: external circuits such as a tape carrier package (TCP) and a printed-circuit board (PCB); optical films such as a viewing angle widening film and a luminance improving film; and a bezel (frame), and such members may be incorporated in another member depending on the types of the members. Members other than the members described above are not particularly limited, and those normally used in the field of liquid crystal display devices can be used, the description of which is therefore omitted here.

The liquid crystal display panel of this embodiment is a fringe field switching (FFS) mode liquid crystal display panel since it includes the TFT substrate 10 having a FFS electrode structure. However, the alignment mode (display mode) of the liquid crystal display panel of this embodiment is not particularly limited, and may be a twisted nematic (TN) mode, an electric-field control birefringence (ECB) mode, an in-plane switching (IPS) mode, a vertical alignment (VA) mode, or a vertical alignment twisted nematic (VATN) mode. Among others, the IPS mode and the FFS mode are preferable, and the FFS mode is particularly preferable. Depending on the alignment mode of the liquid crystal display panel of this embodiment, the electrode structure of the TFT substrate 10 can be changed appropriately.

While the embodiment of the present invention has been described, the individual matters described above are intended to be applicable to the entire of the present invention.

Hereinafter, the present invention will be described in more detail based on examples and comparative examples. It is however to be understood that the present invention is not limited to these examples.

### Examples 1 to 6 and Comparative Examples 1 to 5

A plurality of TFT substrates each having the FFS structure shown in FIG. 1 are prepared. The definition was 330 ppi. The gate electrode was constituted by a laminated film of a 300 nm-thick copper film and a 30 nm-thick titanium film laminated in this order from the glass substrate side. The gate insulator was constituted by a laminated film of a 300 nm-thick silicon nitride (SiNₓ) film and a 50 nm-thick silicon oxide (SiO₂) film laminated from the gate electrode side. The channel layer was constituted by a 50 nm-thick oxide semiconductor (e.g., an In—Ga—Zn—O semiconductor). The source electrode and the drain electrode were constituted by a laminated film of a 300 nm-thick copper film and a 30 nm-thick titanium film laminated in this order from the glass substrate side. The channel protection film was constituted by a 300 nm-thick silicon oxide (SiO₂) film and a 50 nm-thick silicon nitride (SiNₓ) film laminated from the channel layer side. The resin film was constituted by a 2.0 μm-thick acrylic resin film. The common electrode was constituted by a 100 nm-thick ITO film. The insulating film (interlayer insulating film) was constituted by a 150 nm-thick silicon nitride (SiNₓ) film. The pixel electrode was constituted by a 100 nm-thick ITO film. The contact hole size was 2.0 μm in depth and 6 μm in minimum diameter. Imposition was made for the TFT substrates so that 60 panels could be acquired from one mother glass.

Thereafter, liquid crystal aligning agents of examples and comparative examples shown in Table 1 below were prepared, and applied to different TFT substrates by the ink-jet application method. As the alignment film polymer (solid content) of the liquid crystal aligning agents, a polymer having polyamic acid as the main ingredient was used. The surface tension and boiling point of each solvent used are as shown in Table 2 below.

After the application, leveling was performed for 1 minute, and then pre-drying (pre-baking) was performed at 80° C. for 3 minutes.

The TFT substrates each having the thus-formed alignment film were observed with an optical microscope. As a result, ink repelling was confirmed around contact holes for some TFT substrates. The contact hole burying rate (CH burying rate) was calculated for each TFT substrate, and the results were summarized as shown in Table 1. The contact hole burying rate (%) was determined by observing a 5 cm×5 cm square region of the TFT substrate with an optical microscope and calculating the formula, (number of contact holes having caused repelling in the region)÷(total number of contact holes in the region)×100.

Thereafter, the TFT substrate was panelized by a general method to produce liquid crystal display panels, and the panel yield per mother glass was calculated. The panel yield (%) was determined by lighting the produced liquid crystal display panels to check for display defects such as unevenness, black spots, and white spots caused by repelling and calculating the formula, (number of panels having a defect visually recognized)÷(total number of panels tested)×100. The panel yields of the examples and comparative examples were as shown in Table 1. A panel yield of 70% or more was determined as having no production problem. The thicknesses of the alignment films on all the substrates after the full-scale drying (baking) were 100 nm.

TABLE 1

| | | | | | | | Proportion | | |
|---|---|---|---|---|---|---|---|---|---|
| | | | | | | | of DIBK | CH | |
| | Solid | Good solvent | | Poor solvent | | | in poor | burying | Panel |
| | content | NMP | γBL | BC | BDM | DIBK | solvent | rate | yield |
| | (wt %) | (wt %) | (wt %) | (wt %) | (wt %) | (wt %) | (%) | (%) | (%) |
| Com. Example 1 | 4 | 50 | 20 | 26 | | | 0 | 60 | 0 |
| Com. Example 2 | 4 | 50 | 20 | 21 | | 5 | 19 | 80 | 0 |
| Com. Example 3 | 4 | 50 | 20 | 19 | | 7 | 27 | 90 | 0 |
| Com. Example 4 | 4 | 50 | 20 | 16 | 10 | | 0 | 60 | 0 |
| Com. Example 5 | 4 | 50 | 20 | 11 | 15 | | 0 | 60 | 0 |
| Example 1 | 4 | 50 | 20 | 16 | | 10 | 38 | 99 | 78 |
| Example 2 | 4 | 50 | 20 | 14 | | 12 | 46 | 99 | 84 |
| Example 3 | 4 | 50 | 20 | 11 | | 15 | 58 | 99 | 82 |
| Example 4 | 4 | 50 | 20 | 8 | | 18 | 69 | 99 | 83 |
| Example 5 | 3 | 51 | 20 | 16 | | 10 | 38 | 99 | 82 |
| Examole 6 | 3 | 51 | 20 | 11 | | 15 | 58 | 99 | 91 |

TABLE 2

| | | Surface | Boiling |
|---|---|---|---|
| | | tension | point |
| | | (mN/m) | (° C.) |
| NMP | N-methyl-2-pyrrolidone | 41 | 202 |
| γBL | γ-butyrolactone | 44 | 204 |
| BC | butyl cellosolve | 28 | 170 |
| BDM | diethylene glycol butyl methyl ether | 24 | 212 |
| DIBK | diisobutyl ketone | 24 | 169 |

From the above results, it was found that the contact hole burying rate was extremely low with less than 10% by weight of DIBK, and use of 10% by weight or more of DIBK was essential.

Also, as seen from the results of Comparative Examples 4 and 5, use of BDM having a surface tension as low as that of DIBK failed to improve the contact hole burying rate. It is considered that DIBK plays a role like a surfactant, reducing the interface tension at the surface of the TFT substrate thereby assisting flow of the liquid crystal aligning agent into contact holes. In the conventional material development, inks having low surface tension have been developed to improve the application property. However, it has been found that, even though lowering of the surface tension has been achieved, it is required to include 10% by weight or more of DIBK for the purpose of uniform application of the ink to a high-definition substrate.

From the results of Examples 2 to 4, it has been found that 12% by weight or more of DIBK is preferably used from the viewpoint of the panel yield.

From Example 5, it has been found that decreasing the concentration of the solid content reduces the viscosity of the liquid crystal aligning agent, thereby improving the wettability. Further, as a result of increase in the discharge amount of the liquid crystal aligning agent itself made to secure the same thickness of the alignment film after drying of the solvent, the application property improved.

In Example 6 in which the concentration of the solid content decreased and DIBK increased, a very high panel yield was achieved.

### Examples 7 to 14

The steps were carried out in the same manner as in Examples 1 to 6 and Comparative Examples 1 to 5, except that the thicknesses of the insulating films of the TFT substrate were changed as in Table 3 below, and the contact hole burying rate and the panel yield were measured. The contact hole burying rates and the panel yields in Examples 7 to 14 are shown in Table 3 below.

TABLE 3

| | Channel | Channel | | Insu- | | |
|---|---|---|---|---|---|---|
| | protection | protection | Acrylic | lating | CH | |
| | film | film | resin | film | burying | Panel |
| | SiO₂ | SiNx | film | SiNx | rate | yield |
| | (nm) | (nm) | (nm) | (nm) | (%) | (%) |
| Example 1 | 300 | 50 | 2000 | 150 | 99 | 78 |
| Example 7 | 300 | 100 | 2000 | 150 | 99 | 74 |
| Example 8 | 300 | 150 | 2000 | 150 | 99 | 71 |
| Example 9 | 200 | 100 | 2000 | 150 | 99 | 74 |
| Example 10 | 400 | 100 | 2000 | 150 | 99 | 74 |
| Example 11 | 300 | 100 | 1500 | 150 | 99 | 74 |
| Example 12 | 300 | 100 | 2500 | 150 | 99 | 74 |
| Example 13 | 300 | 100 | 2000 | 100 | 99 | 79 |
| Example 14 | 300 | 100 | 2000 | 200 | 99 | 77 |

From the above results, it has been found that, using the liquid crystal aligning agent with increased DIBK, even when the thickness of the nitride insulating film such as the silicon nitride (SiNₓ) film is large or even when the thicknesses of the resin film and other insulating films are changed, the application property can be sufficiently ensured.

### Example 15

The steps were carried out in the same manner as in Examples 1 to 6 and Comparative Examples 1 to 5, except that, in place of the polymer having polyamic acid as the main ingredient, a polyamic acid including an alkyl chain expressed by —(CH₂)—(CH₂)— in its structure (main chain) was used as the alignment film polymer (solid content), and the contact hole burying rate and the panel yield were measured.

### Example 16

The steps were carried out in the same manner as in Examples 1 to 6 and Comparative Examples 1 to 5, except that, in place of the polymer having polyamic acid as the main ingredient, a polyamic acid including an alkyl chain expressed by —(CH₂)₅— in its structure (main chain) was used as the alignment film polymer (solid content), and the contact hole burying rate and the panel yield were measured.

### Example 17

The steps were carried out in the same manner as in Examples 1 to 6 and Comparative Examples 1 to 5, except that, in place of the polymer having polyamic acid as the main ingredient, a polyamic acid including fluorine (F) in its structure (side-chain end) was used as the alignment film polymer (solid content), and the contact hole burying rate and the panel yield were measured.

### Example 18

The steps were carried out in the same manner as in Examples 1 to 6 and Comparative Examples 1 to 5, except that, in place of the polymer having polyamic acid as the main ingredient, two kinds of polymers were used as the alignment film polymer (solid content), and the contact hole burying rate and the panel yield were measured. The two kinds of polymers were both polymers having polyamic acid as the main ingredient. The surface energy of a layer formed of only one of the polymers was 45 mJ/m², and the surface energy of a layer formed of only the other polymer was 57 mJ/m², with a difference of 12 mJ/m² therebetween. The layer formed of only the former polymer is lower in surface energy and is more hydrophobic than the layer formed of only the latter polymer. As a result of separation into two layers, the layer formed of the former polymer functions as the liquid crystal alignment layer but has a concern of adversely affecting the application property.

The contact hole burying rates and the panel yields in Examples 15 to 18 are shown in Table 4 below.

TABLE 4

| | | CH burying | Panel |
|---|---|---|---|
| | | rate | yield |
| | Structure/kind of solid content | (%) | (%) |
| Example 1 | Polymer including polyamic acid as | 99 | 78 |
| | main ingredient | | |
| Example 15 | Polyamic acid including | 99 | 75 |
| | —(CH₂)—(CH₂)— | | |
| | in structure | | |
| Example 16 | Polyamic acid including | 99 | 71 |
| | —(CH₂)₅— | | |
| | in structure | | |
| Example 17 | Polyamic acid including F | 99 | 74 |
| | (fluorine) in structure | | |
| Example 18 | Made of 2 kinds of polymers | 99 | 76 |

From the results of Examples 15 and 16, it has been found that, even when the alignment film polymer includes an alkyl chain exhibiting hydrophobicity, application can be made without problems by using the solvent composition according to the present invention.

From the results of Example 17, it has been found that, even when the alignment film polymer includes fluorine atoms exhibiting hydrophobicity, application can be made without problems by using the solvent composition according to the present invention.

From the results of Example 18, it has been found that, even when an alignment film of which the upper layer (liquid crystal alignment layer) has a polymer structure exhibiting hydrophobicity is formed, application can be made without problems by using the solvent composition according to the present invention.

### Comparative Examples 6 to 13

The steps were carried out in the same manner as in Examples 1 to 3 and Comparative Examples 1 to 5, except that the silicon nitride (SiNₓ) film of the channel protection film was not formed, and the contact hole burying rate and the panel yield were measured. The thicknesses of the insulating films in Comparative Examples 6 to 13 are shown in Table 5 below, and the contact hole burying rates and the panel yields in Comparative Examples 6 to 13 are shown in Table 6.

TABLE 5

| | Channel | Channel | Acrylic | |
|---|---|---|---|---|
| | protection | protection | resin | Insulating |
| | film SiO₂ | film SiNx | film | film SiNx |
| | (nm) | (nm) | (nm) | (nm) |
| Comparative | 300 | 0 | 2000 | 150 |
| Examples 6-13 | | | | |

TABLE 6

| | | | | | | | Proportion | | |
|---|---|---|---|---|---|---|---|---|---|
| | | | | | | | of DIBK | CH | |
| | Solid | Good solvent | | Poor solvent | | | in poor | burying | Panel |
| | content | NMP | γBL | BC | BDM | BC | solvent | rate | yield |
| | (wt %) | (wt %) | (wt %) | (wt %) | (wt %) | (wt %) | (%) | (%) | (%) |
| Com. Example 6 | 4 | 50 | 20 | 26 | | | 0 | 92 | 42 |
| Com. Example 7 | 4 | 50 | 20 | 21 | | 5 | 19 | 99 | 86 |
| Com. Example 8 | 4 | 50 | 20 | 19 | | 7 | 27 | 99 | 85 |
| Com. Example 9 | 4 | 50 | 20 | 16 | 10 | | 0 | 99 | 77 |
| Com. Example 10 | 4 | 50 | 20 | 11 | 15 | | 0 | 99 | 83 |
| Com. Example 11 | 4 | 50 | 20 | 16 | | 10 | 38 | 99 | 85 |
| Com. Example 12 | 4 | 50 | 20 | 14 | | 12 | 46 | 99 | 86 |
| Com. Example 13 | 4 | 50 | 20 | 11 | | 15 | 58 | 99 | 87 |

As seen from the above results, it was possible to prevent repelling for the TFT substrate using no silicon nitride (SiNₓ) film in the channel protection film irrespective of whether the DIBK amount was large or small. It was also possible to sufficiently prevent repelling even when using BDM.

However, when these liquid crystal display panels having no silicon nitride (SiNₓ) film were stored (aged) for 500 hours under a high-temperature, high-humidity environment of 60° C. and 90% RH and then checked for display unevenness on a solid screen with 32 levels out of the highest 256-level gray scale, unevenness was visually recognized. In particular, remarkable unevenness was confirmed around the sealing. This is considered due to the influence of moisture having intruded into the liquid crystal layer during the storage.

Therefore, when using an oxide semiconductor, it is necessary to provide a nitride insulating film such as a silicon nitride (SiNₓ) film in the channel protection film. In this case, a multilayer film made of the silicon oxide (SiO₂) film, the nitride insulating film, and the resin film is to be formed near the bottom of each contact hole, and this is considered to easily form steps and thus cause ink repelling. For this reason, it has been found that, when a nitride insulating film such as a silicon nitride (SiNₓ) film is formed as an additional layer of the channel protection film, DIBK as a solvent having low surface tension is essential and the required amount of DIBK has a definite threshold, i.e., the DIBK amount must be 10% by weight or more, as demonstrated above in Table 1, etc.

### Examples 19 to 21 and Comparative Examples 14 to 18

The steps were carried out in the same manner as in Examples 1 to 3 and Comparative Examples 1 to 5, except that the definition was changed from 330 ppi to 220 ppi, and the contact hole burying rate and the panel yield were measured. The contact hole burying rates and the panel yields in Examples 19 to 21 and Comparative Examples 14 to 18 are shown in Table 7 below.

TABLE 7

| | | | | | | | Proportion | | |
|---|---|---|---|---|---|---|---|---|---|
| | | | | | | | of DIBK | CH | |
| | Solid | Good solvent | | Poor solvent | | | in poor | burying | Panel |
| | content | NMP | γBL | BC | BDM | DIBK | solvent | rate | yield |
| | (wt%) | (wt %) | (wt %) | (wt %) | (wt %) | (wt %) | (%) | (%) | (%) |
| Com. Example 14 | 4 | 50 | 20 | 26 | | | 0 | 95 | 55 |
| Com. Example 15 | 4 | 50 | 20 | 21 | | 5 | 19 | 99 | 82 |
| Com. Example 16 | 4 | 50 | 20 | 19 | | 7 | 27 | 99 | 85 |
| Com. Example 17 | 4 | 50 | 20 | 16 | 10 | | 0 | 99 | 83 |
| Com. Example 18 | 4 | 50 | 20 | 11 | 15 | | 0 | 99 | 83 |
| Example 19 | 4 | 50 | 20 | 16 | | 10 | 38 | 99 | 86 |
| Example 20 | 4 | 50 | 20 | 14 | | 12 | 46 | 99 | 88 |
| Example 21 | 4 | 50 | 20 | 11 | | 15 | 58 | 99 | 87 |

The TFT substrates of Examples 19 to 21 and Comparative Examples 14 to 18 are comparatively low in definition and thus low in the density of contact holes. That is, the length of flat portions between adjacent contact holes is large. Therefore, irrespective of whether the DIBK amount was large or small, it was possible to prevent repelling. It was also possible to sufficiently prevent repelling even when using BDM.

It has been found, however, that, in fabrication of a high-definition (preferably 300 ppi or higher) display, DIBK as a solvent having low surface tension is essential and the required amount of DIBK has a definite threshold, i.e., the DIBK amount must be 10% by weight or more, as demonstrated above in Table 1, etc.

### [Additional Remarks]

One aspect of the present invention may be a liquid crystal aligning agent for a TFT substrate containing a polymer (alignment film polymer) and a solvent, wherein the liquid crystal aligning agent contains 10% by weight or more of diisobutyl ketone (DIBK) relative to the total weight, the TFT substrate (10) includes a channel protection film (26), and the channel protection film (26) includes an insulating film (nitride insulating film) containing silicon and nitrogen.

In the liquid crystal aligning agent for a TFT substrate of the above aspect, the TFT substrate (10) includes the channel protection film (26), and the channel protection film (26) includes an insulating film (nitride insulating film) containing silicon and nitrogen. However, since the agent contains 10% by weight or more of diisobutyl ketone (DIBK) relative to the total weight, decrease in panel yield caused by ink repelling can be prevented.

The definition of the TFT substrate (10) may be 300 ppi or more. For such a TFT substrate (10), also, ink repelling can be sufficiently prevented by use of the liquid crystal aligning agent for a TFT substrate of the above aspect.

The TFT substrate (10) may be provided with a contact hole (CH) having a depth (D) of 2 μm or more. For such a TFT substrate (10), also, ink repelling can be sufficiently prevented by use of the liquid crystal aligning agent for a TFT substrate of the above aspect.

The liquid crystal aligning agent may be applied to the TFT substrate (10) by an ink-jet application method. The ink-jet application method tends to cause ink repelling compared with other application methods such as a printing method. Even by such an ink-jet application method, ink repelling can be sufficiently prevented by use of the liquid crystal aligning agent of this embodiment.

The liquid crystal aligning agent may contain one or more kinds of poor solvents including diisobutyl ketone (DIBK), and the proportion of diisobutyl ketone (DIBK) in the one or more kinds of poor solvents may be 30% or more. This can lead to reduction in the amount of an unnecessary residual solvent after the application and baking of the liquid crystal aligning agent of this embodiment, contributing to improvement in the reliability of the liquid crystal alignment film formed. The reason is that DIBK is low in boiling point compared with other poor solvents (alcoholic and ether solvents generally used as poor solvents).

The concentration of the polymer (alignment film polymer) in the liquid crystal aligning agent may be 4% by weight or less. This reduces the viscosity of the liquid crystal aligning agent of this embodiment, thereby further improving the wettability.

The TFT substrate (10) may include a TFT including an oxide semiconductor. For such a TFT substrate (10), also, ink repelling can be sufficiently prevented by use of the liquid crystal aligning agent for a TFT substrate of the above aspect.

The oxide semiconductor may be indium gallium zinc oxide (an In—Ga—Zn—O semiconductor). In such a case, also, ink repelling can be sufficiently prevented by use of the liquid crystal aligning agent for a TFT substrate of the above aspect.

The thickness of the insulating film (nitride insulating film) may be 50 nm or more. In such a case, also, ink repelling can be sufficiently prevented by use of the liquid crystal aligning agent for a TFT substrate of the above aspect.

The polymer (alignment film polymer) may include at least one kind of polymer selected from the group consisting of polyamic acid and soluble polyimide. Such a polyamic acid polymer has high actual performance in use as an alignment film material, and, using this, a liquid crystal display panel with high reliability and high liquid crystal alignment property can be obtained. The polyamic acid polymer also has an advantage of being capable of selecting a wide range of materials when two or more kinds of polymers described later are used or when an alkylene group, fluorine, etc. are introduced into the polymer. This advantage contributes to the high reliability and the high liquid crystal alignment property.

The polymer (alignment film polymer) may contain a linear alkylene group with two or more carbons. Using such a polymer, also, ink repelling can be sufficiently prevented by use of the liquid crystal aligning agent for a TFT substrate of the above aspect.

The polymer (alignment film polymer) may contain a fluorine atom. Using such a polymer, also, ink repelling can be sufficiently prevented by use of the liquid crystal aligning agent for a TFT substrate of the above aspect.

The polymer may include two or more kinds of polymers (alignment polymers). In such a case, also, ink repelling can be sufficiently prevented by use of the liquid crystal aligning agent for a TFT substrate of the above aspect.

Another aspect of the present invention may be a liquid crystal display panel including a liquid crystal alignment film (31) formed with the liquid crystal aligning agent for a TFT substrate of the above aspect on the TFT substrate (10).

The liquid crystal display panel of the above aspect, which includes the liquid crystal alignment film (31) formed with the liquid crystal aligning agent for a TFT substrate of the above aspect on the TFT substrate (10), can prevent the decrease in panel yield caused by ion repelling.

Yet another aspect of the present invention may be a method for fabricating a liquid crystal display panel including a TFT substrate (10), the TFT substrate (10) including a channel protection film (26), and the channel protection film (26) including an insulating film (nitride insulating film) containing silicon and nitrogen, the fabrication method including a step of applying a liquid crystal aligning agent containing a polymer (alignment film polymer) and a solvent to the TFT substrate (10) to form the liquid crystal alignment film (31), and the liquid crystal aligning agent contains 10% by weight or more of diisobutyl ketone (DIBK) relative to a total weight.

In the method for fabricating a liquid crystal display panel of the above aspect, the TFT substrate (10) includes the channel protection film (26), and the channel protection film (26) includes an insulating film (nitride insulating film) containing silicon and nitrogen. However, since the method includes the step of applying a liquid crystal aligning agent containing 10% by weight or more of diisobutyl ketone (DIBK) relative to the total weight to the TFT substrate (10) to form the liquid crystal alignment film (31), the decrease in panel yield caused by ink repelling can be prevented.

The definition of the TFT substrate (10) may be 300 ppi or more. For such a TFT substrate (10), also, ink repelling can be sufficiently prevented by using the method for fabricating a liquid crystal display panel of the above aspect.

The TFT substrate (10) may have a contact hole (CH) having a depth (D) of 2 μm or more. For such a TFT substrate (10), also, ink repelling can be sufficiently prevented by using the method for fabricating a liquid crystal display panel of the above aspect.

The liquid crystal aligning agent may be applied to the TFT substrate (10) by an ink-jet application method. The ink-jet application method tends to cause ink repelling compared with other application methods such as a printing method. Even by such an ink-jet application method, ink repelling can be sufficiently prevented by use of the liquid crystal aligning agent of this embodiment.

The liquid crystal aligning agent may contain one or more kinds of poor solvents including diisobutyl ketone (DIBK), and the proportion of diisobutyl ketone (DIBK) in the one or more kinds of poor solvents may be 30% or more. This can lead to reduction in the amount of an unnecessary residual solvent after the application and baking of the liquid crystal aligning agent of this embodiment, contributing to improvement in the reliability of the liquid crystal alignment film formed. The reason is that DIBK is low in boiling point compared with other poor solvents (alcoholic and ether solvents generally used as poor solvents).

The concentration of the polymer (alignment film polymer) in the liquid crystal aligning agent may be 4% by weight or less. This reduces the viscosity of the liquid crystal aligning agent of this embodiment, thereby further improving the wettability.

The TFT substrate (10) may include a TFT including an oxide semiconductor. For such a TFT substrate (10), also, ink repelling can be sufficiently prevented by using the method for fabricating a liquid crystal display panel of the above aspect.

The oxide semiconductor may be indium gallium zinc oxide (an In—Ga—Zn—O semiconductor). In such a case, also, ink repelling can be sufficiently prevented by using the method for fabricating a liquid crystal display panel of the above aspect.

The thickness of the insulating film (nitride insulating film) may be 50 nm or more. In such a case, also, ink repelling can be sufficiently prevented by using the method for fabricating a liquid crystal display panel of the above aspect.

The polymer (alignment film polymer) may include at least one kind of polymer selected from the group consisting of polyamic acid and soluble polyimide. Such a polyamic acid polymer has high actual performance in use as an alignment film material, and, using this, a liquid crystal display panel with high reliability and high liquid crystal alignment property can be obtained. The polyamic acid polymer also has an advantage of being capable of selecting a wide range of materials when two or more kinds of polymers described later are used or when an alkylene group, fluorine, etc. are introduced into the polymer. This advantage contributes to the high reliability and the high liquid crystal alignment property.

The polymer (alignment film polymer) may contain a linear alkylene group with two or more carbons. Using such a polymer, also, ink repelling can be sufficiently prevented by using the method for fabricating a liquid crystal display panel of the above aspect.

The polymer (alignment film polymer) may contain a fluorine atom. Using such a polymer, also, ink repelling can be sufficiently prevented by using the method for fabricating a liquid crystal display panel of the above aspect.

The polymer may include two or more kinds of polymers (alignment polymers). In such a case, also, ink repelling can be sufficiently prevented by using the method for fabricating a liquid crystal display panel of the above aspect.

The aspects of the present invention described above may appropriately be combined within the spirit of the present invention.

### REFERENCE SIGNS LIST

10 TFT substrate
21 substrate
22g gate electrode
23 gate insulator
24 channel layer
25s source electrode
25d drain electrode
26 channel protection film (passivation film)
27 resin film
28 common electrode
29 insulating film (interlayer insulating film)
30 pixel electrode
31 alignment film (liquid crystal alignment film)
CH contact hole
D depth of contact hole

1. A liquid crystal aligning agent for a TFT substrate, comprising
a polymer and
a solvent,
wherein the liquid crystal aligning agent contains 10% by weight or more of diisobutyl ketone relative to a total weight,
the TFT substrate includes a channel protection film, and
the channel protection film includes an insulating film containing silicon and nitrogen.

2. The liquid crystal aligning agent for a TFT substrate according to claim 1,
wherein the liquid crystal aligning agent contains one or more kinds of poor solvents including diisobutyl ketone, and
a proportion of diisobutyl ketone in the one or more kinds of poor solvents is 30% or more.

3. The liquid crystal aligning agent for a TFT substrate according to claim 1,
wherein a concentration of the polymer in the liquid crystal aligning agent is 4% by weight or less.

4. The liquid crystal aligning agent for a TFT substrate according to claim 1,
wherein the polymer includes at least one kind of polymer selected from the group consisting of polyamic acid and soluble polyimide.

5. The liquid crystal aligning agent for a TFT substrate according to claim 1,
wherein the polymer contains a linear alkylene group with two or more carbons.

6. The liquid crystal aligning agent for a TFT substrate according to claim 1,
wherein the polymer contains a fluorine atom.

7. The liquid crystal aligning agent for a TFT substrate according to claim 1,
wherein the polymer includes two or more kinds of polymers.

8. A method for fabricating a liquid crystal display panel including a TFT substrate,
the TFT substrate including a channel protection film, and
the channel protection film including an insulating film containing silicon and nitrogen,
the method comprising a step of applying a liquid crystal aligning agent containing a polymer and a solvent to the TFT substrate to form a liquid crystal alignment film, and
the liquid crystal aligning agent contains 10% by weight or more of diisobutyl ketone relative to a total weight.

9. The method for fabricating a liquid crystal display panel according to claim 8,
wherein a definition of the TFT substrate is 300 ppi or more.

10. The method for fabricating a liquid crystal display panel according to claim 8,
wherein the TFT substrate is provided with a contact hole having a depth of 2 μm or more.

11. The method for fabricating a liquid crystal display panel according to claim 8,
wherein the liquid crystal aligning agent is applied to the TFT substrate by an ink-jet application method.

12. The method for fabricating a liquid crystal display panel according to claim 8,
wherein the liquid crystal aligning agent contains one or more kinds of poor solvents including diisobutyl ketone, and
the proportion of diisobutyl ketone in the one or more kinds of poor solvents is 30% or more.

13. The method for fabricating a liquid crystal display panel according to claim 8,
wherein the concentration of the polymer in the liquid crystal aligning agent is 4% by weight or less.

14. The method for fabricating a liquid crystal display panel according to claim 8,
wherein the TFT substrate includes a TFT containing an oxide semiconductor.

15. The method for fabricating a liquid crystal display panel according to claim 14,
wherein the oxide semiconductor is indium gallium zinc oxide.

16. The method for fabricating a liquid crystal display panel according to claim 8,
wherein a thickness of the insulating film is 50 nm or more.

17. The method for fabricating a liquid crystal display panel according to claim 8,
wherein the polymer includes at least one kind of polymer selected from the group consisting of polyamic acid and soluble polyimide.

18. The method for fabricating a liquid crystal display panel according to claim 8,
wherein the polymer contains a linear alkylene group with two or more carbons.

19. The method for fabricating a liquid crystal display panel according to claim 8,
wherein the polymer contains a fluorine atom.

20. The method for fabricating a liquid crystal display panel according to claim 8,
wherein the polymer includes two or more kinds of polymers.
